(19) United States
(12) Patent Application Publication
(10) Pub. No.: US 2015/0290086 A1
(43) Pub. Date: Oct. 15, 2015

(54) BOTTOM-VENTED BABY BOTTLE

(71) Applicants: Ruth Prentice, Irvine, CA (US); James J. Britto, Westport, MA (US)

(72) Inventors: Ruth Prentice, Irvine, CA (US); James J. Britto, Westport, MA (US)

(21) Appl. No.: 14/423,330

(22) PCT Filed: Aug. 22, 2012
(86) PCT No.: PCT/US2012/051842

§ 371 Date: Jun. 16, 2015

(51) Int. Cl. A61J 9/04

(52) U.S. Cl. CPC A61J 9/04

(57) ABSTRACT

A baby bottle includes a container having a feeding end and an air inlet end opposite the feeding end, a nipple releasably coupled to the feeding end, and a valve releasably coupled to the air inlet end. The valve includes a body extending into the container when the valve engages the air inlet end of the container, and a membrane recessed relative to the body. The membrane includes a slit, which is configured to open in response to a negative pressure within the container and resiliently close in absence of the negative pressure.

### FIELD OF THE INVENTION

The present invention relates to baby feeding bottles and, more particularly, to vented baby bottles.

### BACKGROUND OF THE INVENTION

A baby bottle for feeding an infant typically includes a bottle and a nipple secured thereto with a collar or ring. In use, the bottle contains a liquid or flowable material or substance such as milk, water, or an infant formula. To alleviate the vacuum created in the bottle during feeding, the bottle may include a vent at on the nipple. The vent allows ambient air from outside the bottle to flow into the bottle while suction is applied to the nipple. At least a portion of the air that flows into the bottle may be trapped in the liquid contained in the bottle, thereby aerating the liquid. When swallowed by the infant, the aerated liquid may potentially increase a likelihood of colic symptoms. Thus, there has developed a need for a baby bottle that can reduce the aeration of the liquid contained therein during feeding.

### SUMMARY OF THE INVENTION

According to an embodiment of the invention, a baby bottle includes a container having a first opening at a first end and a second opening at a second end opposite the first end, a nipple releasably coupled to the first opening, and a valve releasably coupled to the second opening. The valve includes a body extending into the container, and a membrane recessed relative to the body. The membrane includes a slit, which is configured to open in response to a negative pressure within the container and resiliently close in absence of the negative pressure.

According to another embodiment of the invention, a valve for a baby bottle is provided. The baby bottle has a first opening for dispensing a liquid and a second opening opposite the first opening. The valve includes a body configured to be received within the second opening, and a membrane recessed relative to the body. The membrane includes a slit, which is configured to open in response to a negative pressure within the bottle and resiliently close in absence of the negative pressure.

According to another embodiment of the invention, a baby bottle includes a container having a first opening at a first end a second opening at a second end opposite the first end, a nipple releasably coupled to the first end, and a valve releasably coupled to the second end. The valve includes a substantially dome-shaped body configured to be received within the second opening, and a membrane recessed relative to the dome-shaped body. The dome-shaped body extends into an interior of the container. The membrane includes a single slit, which extends substantially linearly. The slit is configured to open in response to a negative pressure within the container and resiliently close in absence of the negative pressure.

Other aspects of the invention will become apparent by consideration of the detailed description and accompanying drawings.

### BRIEF DESCRIPTION OF THE DRAWINGS

FIG. 1 is a side perspective view of a baby bottle constructed and arranged in accordance with embodiments of the present invention;

FIG. 2 is an exploded view of the baby bottle of FIG. 1;

FIG. 3 is an enlarged perspective view of the valve of FIG. 1, illustrating a valve supported on a securing member;

FIG. 4 is a sectional view taken along line 4-4 of FIG. 3;

FIG. 5 is a bottom perspective view of the baby bottle of FIG. 1;

FIG. 6 is an enlarged perspective view of the valve of FIG. 3, illustrating a slit of the valve being closed;

FIG. 7 is an enlarged perspective view of the valve of FIG. 3, illustrating a slit of the valve being open; and

FIG. 8 is an enlarged bottom perspective view of a nipple of the baby bottle illustrated in FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. For example, as used herein, the terms “top,” “bottom,” “front,” “rear,” “side,” “upward,” “downward,” and other directional terms are not intended to require any particular orientation, but are instead used for purposes of description only.

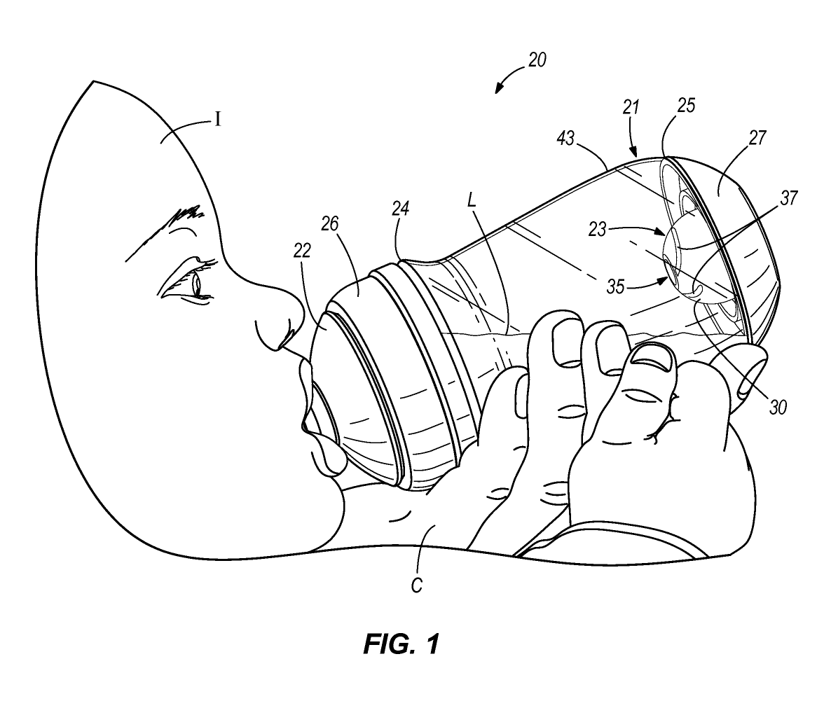

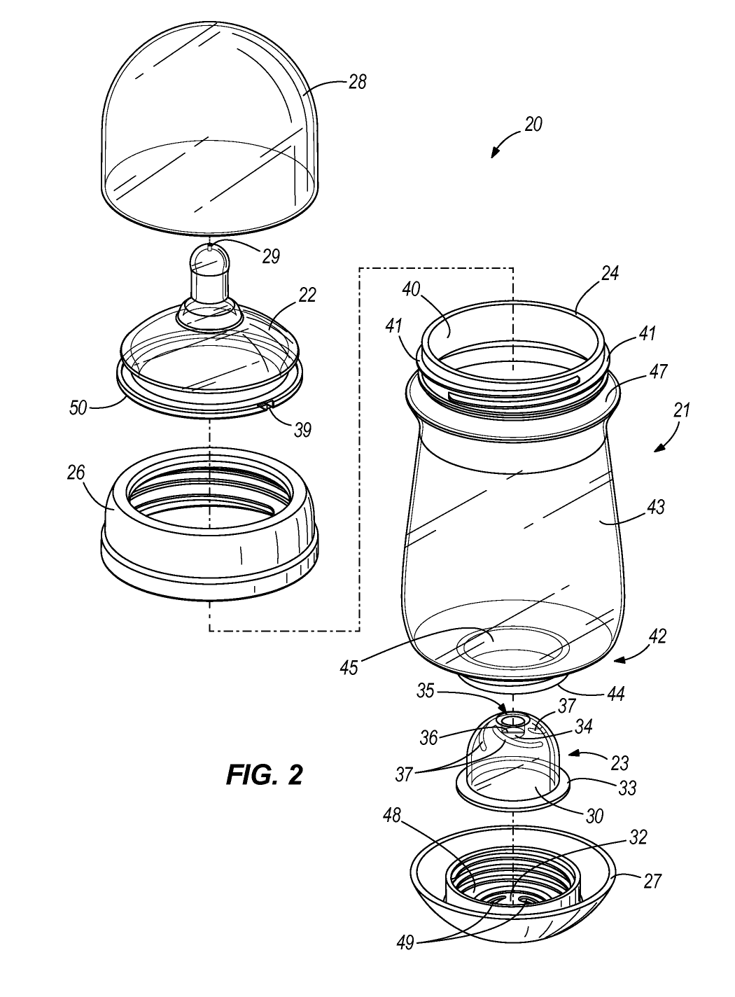

FIG. 1 illustrates a side perspective view of a baby bottle 20 constructed and arranged in accordance with embodiments of the invention. The baby bottle 20 includes a container 21, a nipple 22, and a valve 23. Referring also to FIG. 2, the container 21 includes a first end 24 defining a first opening 40 for receiving a volume of liquid or flowable material or substance L. The first end 24 includes a plurality of threads 41 configured to receive a first collar 26, which releasably couples the nipple 22 to the container 21 to cover the first opening 40. The container 21 also includes a base or bottom 42 at a second end 25, which is opposite the first end 24, and a sidewall 43 connecting the base 42 to the first end 24. The base 42 includes a hollow neck 44 that extends downwardly therefrom and defines a second opening 45 in the container 21. The neck 44 includes a plurality of threads 46 configured to receive a second collar 27, which releasably couples the valve 23 to the container 21 to cover the second opening 45. The second opening 45 has a circumference that is smaller than a circumference of the first opening 40.

In the illustrated embodiment, an optional hood or cover 28 is releasably coupled to the first collar 26 to cover the nipple 22 for sanitary reasons and to prevent spills if the baby bottle 20 is tipped on its side or is inverted. Also, as illustrated in the figures, the sidewall 43 of the container 21 includes contouring whereby the container 21 includes a flange 47 near the first end 24 and below the threads 41. From the outermost portion of the flange 47, the sidewall 43 tapers inwardly and then gradually extends outwardly. In other words, the circumference of the sidewall 43 just below the flange 47 is smaller than a circumference of any other portion of the sidewall 43.

The container 21 is preferably made of a rigid plastic material, such as polycarbonate or polypropylene, which may be substantially transparent or translucent so that the inside of the container 21 and its contents are visible. The container 21 may also comprise a material suitable for aiding a caregiver C in gripping of the bottle 20 and/or ridges or bumps may be formed in the sidewall 43 for aiding in gripping of the bottle 20. In some embodiments, the container 21 can hold a volume of liquid or semi-liquid materials L of about 110 mL to about 270 mL, but in other embodiments, could comprise other volumes.

The nipple 22 includes a pinhole 29 for allowing the liquid L to flow from the inside of the container 21 to the outside of the container 21 and to the infant I. The valve 23 includes a body 30 configured to extend into the container 21 when the valve 23 is coupled within the second opening 45 of the container 21.

In use, the container 21 contains the liquid or flowable material or substance L such as milk or an infant formula for feeding an infant I. The caregiver C may hold the baby bottle 20 at an angle, thereby filling the nipple 22 with the liquid L for feeding the infant I (see FIG. 1). As explained below, the valve 23 is configured to open in response to a negative pressure within the container 21 and resiliently close in absence of the negative pressure 21. The valve 23 thus allows ambient air to flow from outside the container 21 into the container 21 during application of negative pressure to the nipple 22. In the illustrated embodiment, the valve 23 is positioned at the base 42 of the baby bottle 20 when the baby bottle 20 is standing upright. If the container 21 contains the liquid L, and if the baby bottle 20 is in the upright position, a head of the liquid L exerts a static downward pressure on the valve 23. This downward pressure tends to open the valve 23; however, the valve 23 is configured to withstand this opening force as explained below.

In the illustrated embodiment, the body 30 of the valve 23 is substantially dome-shaped. In other embodiments, however, the body 30 may assume any suitable geometric form, including, but not limited to, a conical, a pyramidal, a cylindrical, a regular polyhedral, and an irregular polyhedral shape, derivatives thereof, and combinations thereof. The valve 23 may be formed of a suitable polymeric or thermoset material such as silicone, thermoplastics, elastomers, thermoset rubbers, and the like. In some embodiments, the valve 23 may be formed by liquid injection molding, where the material for the valve 23 is injected under pressure through an injection nozzle into an injection mold. In other embodiments, the valve 23 may be made in other manners from other materials. In some embodiments, the valve 23 may be formed from a substantially transparent or translucent material so that the inside is visible. In other embodiments, the valve 23 may be formed from a suitable material that may be substantially opaque in whole or in part.

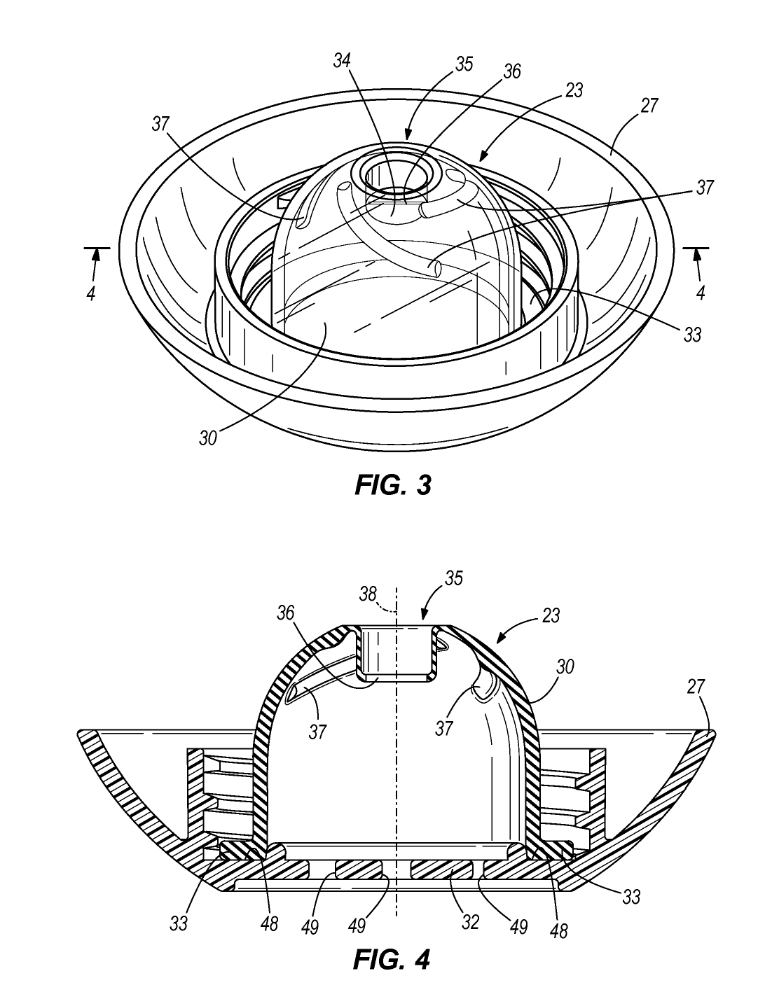

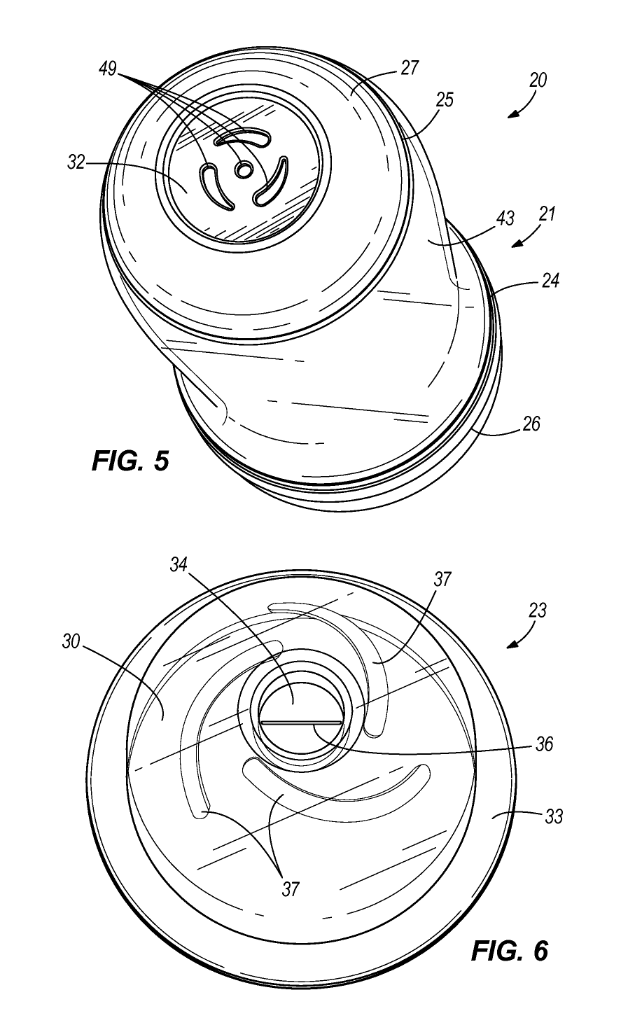

Referring also to FIGS. 3-5, the second collar 27 is configured to removably couple the valve 23 to the second opening 45 of the container 21. In the illustrated embodiment, the second collar 27 includes a recess 48 configured to receive the valve 23. The second collar 27 also includes a bottom surface 32 having a plurality of apertures 49. As described above, the second collar 27 may be screwed on the neck 44 of the container 21. In the illustrated embodiment, the valve 23 includes a support flange 33 (see FIG. 4), which extends along a perimeter of the body 30. Although the support flange 33 can be positioned on the second collar 27, the support flange 33 of the valve 23 is not required to be secured to the second collar 27 before the second collar 27 engages or is fitted to the neck 44 of the container 21. That is, the support flange 33 of the valve 23 may merely rest on the second collar 27 before the second collar 27 engages the neck 44. Because the illustrated embodiment does not require the valve 23 to be secured to the second collar 27, it can make removing and replacing a valve 23 more efficient and user-friendly. Although FIG. 5 illustrates the second collar 27 with a bottom surface 32 partially recessed therein, it is to be appreciated that other embodiments may utilize other configurations without a bottom surface 32 recessed therein. Moreover, although FIG. 5 illustrates the second collar 27 and the valve 23 as being separate, in other embodiments, the second collar 27 and the valve 23 could be co-molded or otherwise integrated. In still other embodiments, the second collar 27 may include other constructions that are suitable for releasably coupling the valve 23 to the second opening 45 of the container 21.

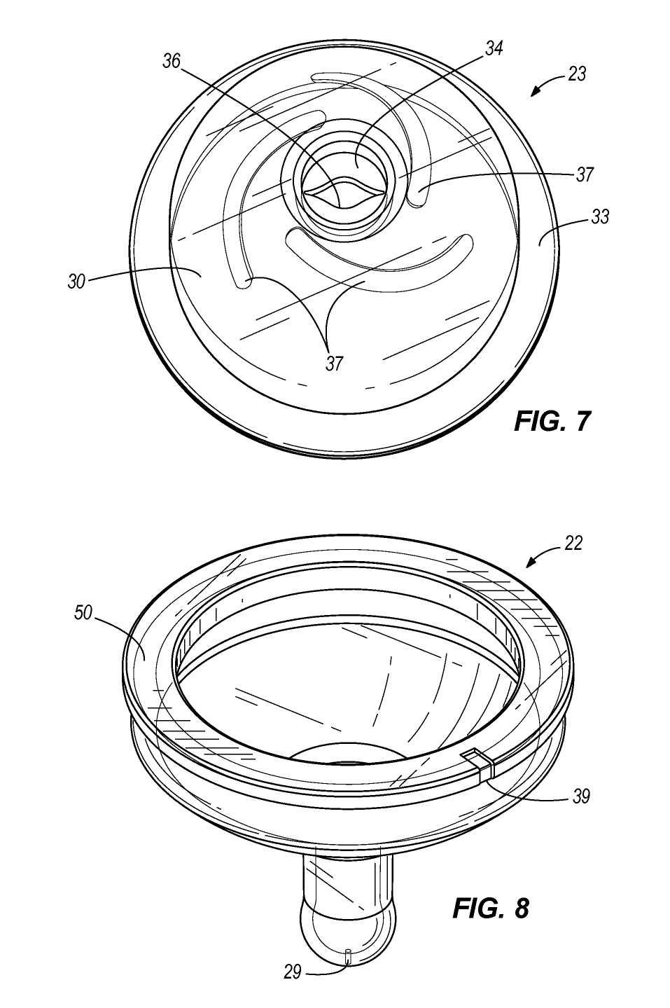

In the illustrated embodiment, the valve 23 includes a membrane 34 recessed relative to the body 30. That is, when the valve 23 engages the second opening 45 of the container 21 (see, e.g., FIG. 2), the membrane 34 is recessed from a distal end 35 of the body 30. Referring also to FIGS. 6 and 7, the membrane 34 includes a slit 36, which is configured to open in response to a negative pressure within the container 21 (see FIG. 7), e.g., when the infant I is applying suction to the nipple 22. The slit 36 may be formed by cutting through the membrane 34 using any suitable technique. In some embodiments, the slit 36 is configured to open upon application of a negative pressure of about 8 mB to about 20 mB.

In absence of the negative pressure (see FIG. 6), e.g., when the infant I stops suction on the nipple 22, the slit 36 of the valve 23 is configured to resiliently close. The response time for the valve 23 to close is so configured as to substantially prevent leakage as the baby bottle 20 is turned from an angled or inverted position to an upright position, with ambient pressure inside. That is, when the pressure inside the container 21 is restored to be substantially the ambient pressure, with the container 21 in the angled or inverted position, the valve 23 will close solely by the resilience of walls of the membrane 34 surrounding the slit 36. Once the slit 36 is closed, and the baby bottle 20 is turned to the upright position, the liquid L contained in the container 21 presents constant or continuous downward forces that tend to open the slit 36. However, the membrane 34 is configured to withstand this opening force by way of the resilience of the valve walls surrounding the slit 36. Thus, once the slit 36 is closed, the flow or leakage of liquid L through the slit 36 is substantially prevented despite the pressure of the head of liquid L.

In the illustrated embodiment, the body 30 of the valve 23 includes reinforcement elements 37 coupled thereto. Each reinforcement element 37 may increase a thickness, stiffness, or both of the body 30 surrounding the membrane 34. Although in the illustrated embodiment the reinforcement elements 37 are three rib-like structures on an underside of the body 30 arranged in a swirling pattern, in other embodiments, the body 30 can suitably include other numbers and/or patterns of reinforcement elements 37. In still other embodiments, the reinforcement elements 37 may be coupled to a top side of the body 30. Depending on the usage requirements or preferences for the particular baby bottle 20, the reinforcement elements 37 may provide the requisite structural rigidity or stiffness for the body 30.

In the illustrated embodiment, the membrane 34 includes a single slit 36 that extends substantially linearly when the slit 36 is in a closed position. In other embodiments, the slit 36 may include one or more arcuate portions in the closed position. In still other embodiments, the membrane 34 may include a plurality of slits 36. In the illustrated embodiment, the body 30 is associated with a longitudinal axis 38, and the slit 36 extends substantially perpendicular to the longitudinal axis 38. In other embodiments, at least a portion of one or more slits 36 may extend at an acute angle to the axis 38. In still other embodiments, at least a portion of one or more slits 36 may extend substantially parallel to the longitudinal axis 38. In some embodiments, two or more slits 36 may intersect one another.

Referring to FIG. 8, the nipple 22 includes a channel 39, which is configured to operate after the valve 23 opens, in response to an additional negative pressure within the container 21. In the illustrated embodiment, the channel 39 is formed on an outer periphery and underside of a flange portion 50 of the nipple 22. When the baby bottle 20 is assembled, the illustrated channel 39 rests on the rim of the first opening 40 of the container 21. An unlimited variety of shapes or designs can be suitable as the channel 39 so long as they are so dimensioned as to selectively allow ambient air to flow from outside the container 21 into the container 21, in response to a negative pressure within the container 21 as explained below. Although FIG. 8 illustrates the channel 39 as positioned in the flange portion 50 of the nipple 22, in other embodiments, the channel 39 may be suitably positioned elsewhere on the nipple 22.

When the infant I applies suction to the nipple 22, the slit 36 in the valve 23 opens first in response to a first negative pressure within the container 21. While the valve 23 is open, with the container 21 in the angled or inverted position, the channel 39 is initially contacted by the liquid L within the container 21. The channel 39 is so dimensioned as to prevent the liquid L from exiting through the channel 39 due to the surface tension of the liquid L, which operates to effectively seal or block the channel 39. As such, the channel 39 can prevent passage of air therethrough when the channel 39 is initially contacted by the liquid L Thus, the air that enters the container 21 initially flows predominantly through the valve 23 and not through the channel 39. This may eliminate aeration of the liquid L and thereby potentially reduce the likelihood of colic symptoms in the infant I.

In case the infant I applies suction to the nipple 22 with a higher force, such as when a higher flow of the liquid L is desired, or if the valve 23 becomes blocked in part, a second negative pressure may be applied within the container 21, which is more negative than the first negative pressure. In response to this second negative pressure, the channel 39 operates to allow ambient air to flow from outside the container 21 into the container 21. That is, the channel 39 is so dimensioned as to allow the second negative pressure to overcome the surface tension of the liquid L. As such, the channel 39 selectively operates to allow passage of air under additional negative pressure within the container 21.

The invention has been described above with reference to a preferred embodiment. However, those skilled in the art will recognize that changes and modifications may be made to the embodiment without departing from the nature and scope of the invention. Various changes and modifications to the embodiment herein chosen for purposes of illustration will readily occur to those skilled in the art. To the extent that such modifications and variations do not depart from the spirit of the invention, they are intended to be included within the scope thereof.

What is claimed is:

1. A baby bottle comprising:
a container having a first opening at a first end and a second opening at a second end opposite the first end;
a nipple releasably coupled to the first opening; and
a valve releasably coupled the second opening, the valve including
a body extending into the container, and
a membrane recessed relative to the body, the membrane including a slit,
wherein the slit is configured to open in response to a first negative pressure within the container and resiliently close in absence of the first negative pressure.

2. The baby bottle according to claim 1, wherein the valve further includes a support flange, the support flange extending along a perimeter of the body.

3. The baby bottle according to claim 1, wherein the body further includes at least one reinforcement element coupled thereto, the reinforcement element increasing a thickness of the body.

4. The baby bottle according to claim 1, wherein the body further includes at least one reinforcement element coupled thereto, the reinforcement element increasing a stiffness of the body.

5. The baby bottle according to claim 1, wherein the slit extends substantially linearly.

6. The baby bottle according to claim 1, wherein the body is associated with a longitudinal axis, and wherein the slit extends substantially perpendicular to the longitudinal axis.

7. The baby bottle according to claim 1, wherein the membrane includes a single slit.

8. The baby bottle according to claim 1, furthering comprising a collar configured to removably couple the valve to the second opening.

9. The baby bottle according to claim 8, wherein the collar includes a bottom surface at least partially recessed therein.

10. The baby bottle according to claim 1, wherein the body is substantially dome-shaped.

11. The baby bottle according to claim 1, wherein the nipple includes a channel, wherein the channel is configured to allow passage of air after the valve opens in response to a second negative pressure within the bottle, and wherein the second negative pressure is more negative than the first negative pressure.

12. A valve for a baby bottle having a first opening for dispensing a liquid and a second opening opposite the first opening, the valve comprising:
a body configured to be received within the second opening; and
a membrane recessed relative to the body, the membrane including a slit,
wherein the slit is configured to open in response to a negative pressure within the bottle and resiliently close in absence of the negative pressure.

13. The valve according to claim 12, wherein the valve further includes a support flange, the support flange extending along a perimeter of the body.

14. The valve according to claim 12, wherein the body further includes at least one reinforcement element coupled thereto, the reinforcement element increasing a thickness of the body.

15. The valve according to claim 12, wherein the body further includes at least one reinforcement element coupled thereto, the reinforcement element increasing a stiffness of the body.

16. The valve according to claim 12, wherein the slit extends substantially linearly.

17. The valve according to claim 12, wherein the body is associated with a longitudinal axis, and wherein the slit extends substantially perpendicular to the longitudinal axis.

18. The valve according to claim 11, wherein the membrane includes a single slit.

19. The valve according to claim 11, wherein the body is substantially dome-shaped.

20. A baby bottle comprising:
a container having a first opening at a first end and a second opening at a second end opposite the first end;
a nipple releasably coupled to the first end; and
a valve releasably coupled to the second end, the valve including
a substantially dome-shaped body configured to be received within the second opening, the body extending into an interior of the container; and
a membrane recessed relative to the dome-shaped body, the membrane including a single slit, wherein the slit extends substantially linearly, and wherein the slit is configured to open in response to a negative pressure within the container and resiliently close in absence of the negative pressure.
